(19) United States
(12) Patent Application Publication
(10) Pub. No.: US 2016/0291967 A1
(43) Pub. Date: Oct. 6, 2016

(54) METHOD AND SYSTEM FOR UPDATING FIRMWARE

(71) Applicant: Konica Minolta Laboratory U.S.A., Inc., San Mateo, CA (US)

(72) Inventor: Subramanyam BADRI, Foster City, CA (US)

(73) Assignee: Konica Minolta Laboratory U.S.A., Inc., San Mateo, CA (US)

(21) Appl. No.: 14/672,546

(22) Filed: Mar. 30, 2015

(51) Int. Cl. G06F 9/44; G06F 9/445

(52) U.S. Cl. CPC G06F 8/68; G06F 8/63

(57) ABSTRACT

A method, a non-transitory computer readable medium, and a system are disclosed for updating firmware in a memory of a device. The method including creating a new firmware image for the device; calculating a checksum of the new firmware image; performing a binary comparison of the new firmware image with an existing firmware image on the device; preparing a new differential data image for the binary comparison of the new firmware image to the existing firmware image; and calculating a checksum of the new differential data image for the binary comparison of the new firmware image to the existing firmware image.

### FIELD OF THE INVENTION

The present disclosure relates to a method and system for updating firmware, and more particularly, a method and system for updating firmware in embedded devices, for example, multifunction printers (MFP), mobile devices and/or tablets.

### BACKGROUND OF THE INVENTION

Firmware updates on embedded devices like printers, and mobile or tablet devices can be carried out with the process of replace the existing firmware in the flash memory. However, if one wants to go back to an older firmware version, there is typically no way in the current situation except over writing with old an image if one has a backup copy of the old firmware.

In addition, new firmware often cannot be stored along with old firmware due to flash memory constrains. For example, if the new firmware has some issues, such that one has to wait for another firmware update with fixes identified in the newly released firmware, it would be desirable to be able to access the old firmware without reimaging the firmware on the device.

### SUMMARY OF THE INVENTION

In accordance with an exemplary embodiment, a method is disclosed for updating firmware in a memory of a device, the method comprising: creating a new firmware image for the device; calculating a checksum of the new firmware image; performing a binary comparison of the new firmware image with an existing firmware image on the device; preparing a new differential data image for the binary comparison of the new firmware image to the existing firmware image; and calculating a checksum of the new differential data image for the binary comparison of the new firmware image to the existing firmware image.

In accordance with an exemplary embodiment, a method is disclosed for updating firmware in a memory of a device, comprising: executing a computer file for installing a new firmware image in the memory of the device, the computer file including a checksum of the new firmware image, a new differential data image, the new differential data image being a binary comparison of the new firmware image to an existing firmware image, and a checksum of the new differential data image; crosschecking a calculated checksum of the new firmware image with the checksum of the new differential data image; obtaining a backed up differential data image of the existing firmware image, the backed up differential data image of the existing firmware image including a checksum, a list of differential addresses, and data length for the existing firmware image; and updating the existing firmware image with the new differential data image on the device to create an updated firmware image on the device.

In accordance with an exemplary embodiment, a non-transitory computer readable medium containing a computer program storing computer readable code for updating firmware in a memory of a device is disclosed, the computer program being executable by a computer to cause the computer to perform a process comprising: creating a new firmware image for the device; calculating a checksum of the new firmware image; performing a binary comparison of the new firmware image with an existing firmware image on the device; preparing a new differential data image for the binary comparison of the new firmware image to the existing firmware image; and calculating a checksum of the new differential data image for the binary comparison of the new firmware image to the existing firmware image.

In accordance with an exemplary embodiment, a non-transitory computer readable medium containing a computer program storing computer readable code for updating firmware in a memory of a device is disclosed, the computer program being executable by a computer to cause the computer to perform a process comprising: executing a computer file for installing a new firmware image in the memory of the device, the computer file including a checksum of the new firmware image, a new differential data image, the new differential data image being a binary comparison of the new firmware image to an existing firmware image, and a checksum of the new differential data image; crosschecking a calculated checksum of the new firmware image with the checksum of the new differential data image; obtaining a backed up differential data image of the existing firmware image, the backed up differential data image of the existing firmware image including a checksum, a list of differential addresses, and data length for the existing firmware image; and updating the existing firmware image with the new differential data image on the device to create an updated firmware image on the device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a system, which includes a first device and an image forming apparatus connected to the first device, wherein at least one of the first device and the image forming apparatus include firmware as disclosed in the accordance with an exemplary embodiment.

FIG. 2 is an illustration showing a new firmware image differential data structure in accordance with an exemplary embodiment.

FIG. 3 is an illustration showing an existing firmware image structure in accordance with an exemplary embodiment.

FIG. 4 is a flow chart showing an exemplary new firmware image differential data creation flowchart in accordance with an exemplary embodiment.

FIGS. 5A and 5B are flow charts showing an exemplary update the existing firmware with received differential data in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

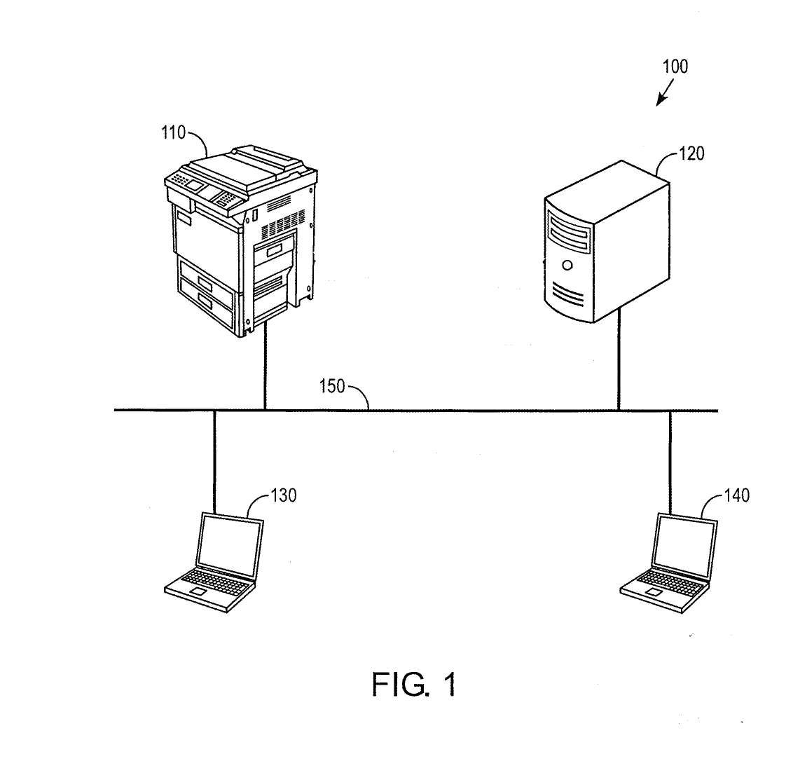

The method and system as described herein can be implemented in a system 100 as shown in FIG. 1. The system 100 can include a first computer device 110, such as an image forming apparatus or a multi-functional printer (MFP), a second computer device 120, which is preferably a computer resource in a manufacture site that can carry out one or more of the methods and processes as disclosed herein, and one more client devices 130, 140. The first computer device 110, the second computer device 120, and the one or more client devices 130, 140 can be connected to one another via a network connection 150.

The first computer device 110 in the form of, for example, an image forming apparatus (or printer) can include a printer controller or firmware, an image processing section (or data dispatcher), a print engine, and an input/output (I/O) section. The controller may include a central processing unit (CPU), a random access memory (RAM), and a read only memory (ROM). The controller processes the data and job information received from the first device 110 to generate a print image. The controller also includes an operating system (OS), which acts as an intermediary between the software programs and hardware components within the image forming apparatus 110. The operating system (OS) manages the computer hardware and provides common services for efficient execution of various application software. In accordance with an exemplary embodiment, the controller can process the data and job information received from the one or more client devices 130, 140 to generate a print image.

The image processing section on the first computer device 110 can carry out various image processing under the control of the controller, and sends the processed print image data to the print engine. The image processing section also can include a scanner section for optically reading a document, such as an image recognition system. The print engine forms an image on a recording sheet based on the image data sent from the image processing section. The I/O section performs data transfer with, for example, the one or more client device 130, 140. The controller is programmed to process data and control various other components of the image forming apparatus to carry out the various methods described herein. The print engine forms an image on a sheet of print medium (for example, a recording sheet) based on the image data sent from the image processing section. The input/output (I/O) port provides communications between the printer section and the one or more client devices 130, 140 and receives page descriptions (or print data) from the host for processing within the first computer device 110.

Examples of image forming apparatuses 110 can include, but are not limited to, a multi-functional printer (MFP), a laser beam printer (LBP), an LED printer, a multi-functional laser beam printer including copy function. In accordance with an embodiment, the image forming apparatus 110 is a color printer or a black and white (B/W) printer. In accordance with another embodiment, the image forming apparatus 110 is configured as a multi-functional printer (MFP) device or all-in-one (AIO) that includes a printer section for converting print data inputted from outside to image data and forming and printing out the converted image onto a printable media, a scanner section for optically reading a document (i.e., an image recognition system), and a facsimile section for facsimile receiving and transmitting image data to and from external apparatuses through public telecommunication lines.

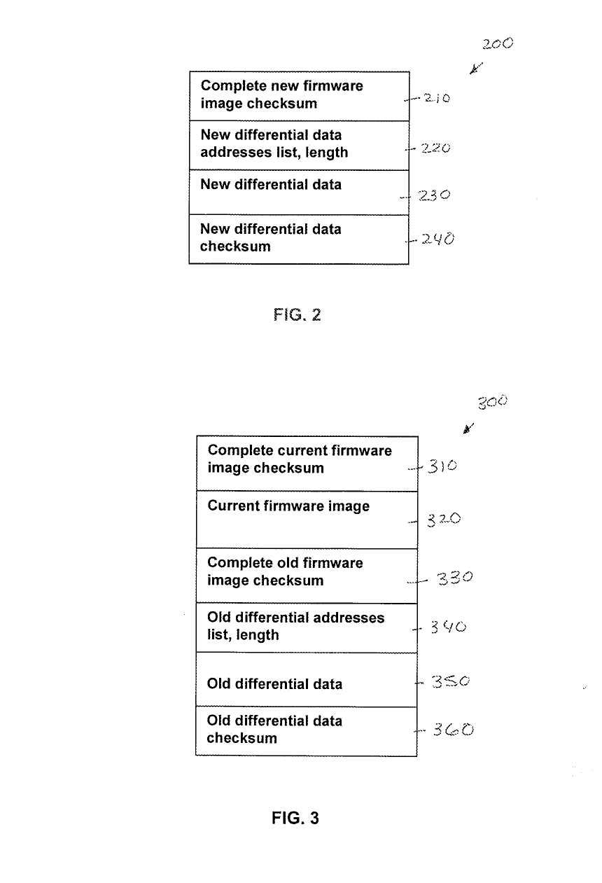

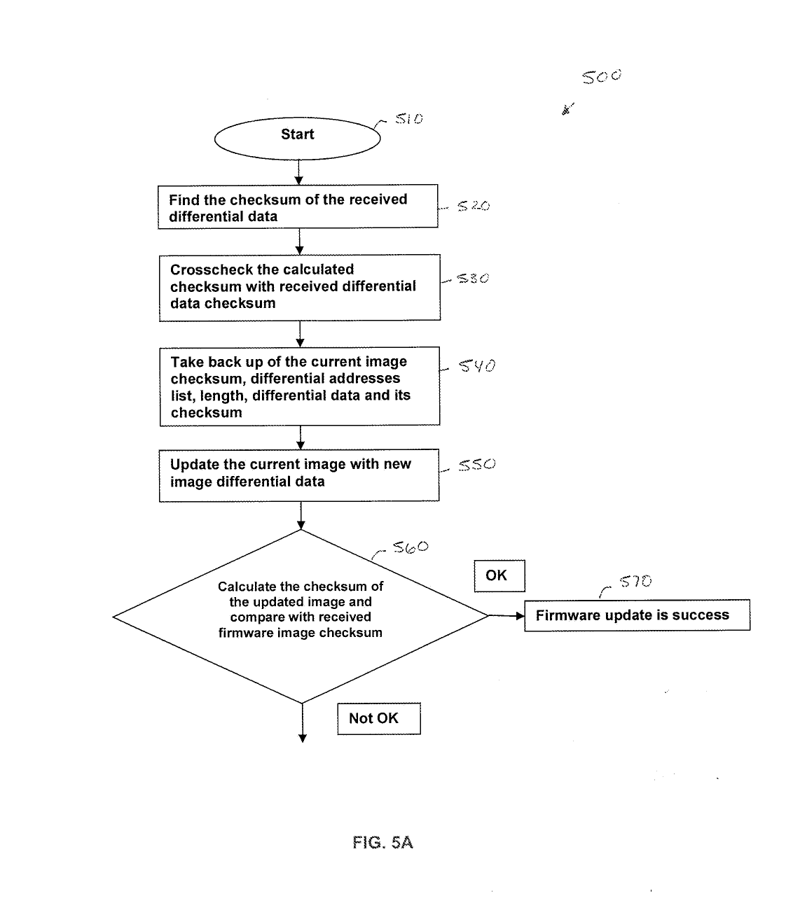

The second computer device 120 is preferably a computer resource at a manufacture site that can host the data structure as shown in FIG. 2, and carry out the methods and processes as shown in FIG. 4. The second computer device 120 can include, for example, a graphical user interface, a processor, an operating system, and one or more memories for storing software programs and data.

In accordance with an exemplary embodiment, the one or more client devices 130, 140 can include a processor and one or more memories for storing software programs and data (such as files to be printed). Examples of the one or more client devices 130, 140 can include computers, personal data assistants, tablets, mobile devices, and the like.

In accordance with an exemplary embodiment, the first computer device 110 and the one or more client devices 130, 140 as described herein, for example, can be embedded devices, which can include a limited memory for storing firmware such that more than one firmware program cannot be stored in the memory of the device 110, 130, 140. Typically, firmware, which can include a combination of a hardware device, for example, an integrated circuit, and software, which is stored in non-volatile memory devices such as ROM (random access memory), EPROM (erasable programmable read only memory), or flash memory. However, in accordance with an exemplary embodiment, with an extra amount of memory, for example, flash memory, an old firmware image can also be stored along with new firmware image in the same device 110, 130, 140. However, it would also be desirable that the user can go back to the old firmware image, when it is necessary and/or required, for example, on a first computer device 110, or the one or more client devices 130, 140 as disclosed herein.

The first computer device 110, the second computer device 120, and the one or more client devices 130, 140 can be connected to one another via a public telecommunication line and/or a network (for example, LAN or WAN) 150. Examples of the telecommunication line and/or network 150 consistent with embodiments of the invention include, but are not limited to, telecommunication or telephone lines, the Internet, an intranet, a local area network (LAN), a wide area network (WAN) and/or a wireless connection using radio frequency (RF) and/or infrared (IR) transmission.

In accordance with an exemplary embodiment, the method for updating firmware can include performing a binary comparison of an existing firmware image with a newly created firmware image, and preparing a differential data image, which includes a list of addresses and data lengths obtained from the binary comparison. A checksum can then be calculated based on the differential data image and its differential data checksum. The non-volatile memory of the device 110, 130, 140, for example, a flash storage area of the device 110, 130, 140 can be organized such that the current firmware image is updated with the differential data. If the firmware updating process fails or a user requests to restore the firmware of the device with the old firmware image, the request can be performed with the backup data from the differential data.

FIG. 2 is an illustration showing a new firmware image differential data structure 200 in accordance with an exemplary embodiment. As shown in FIG. 2, the new firmware image differential structure 200 includes a complete new firmware image checksum 210, a new differential data addresses and data length 220, a new differential data image 230, and a new differential data checksum 240.

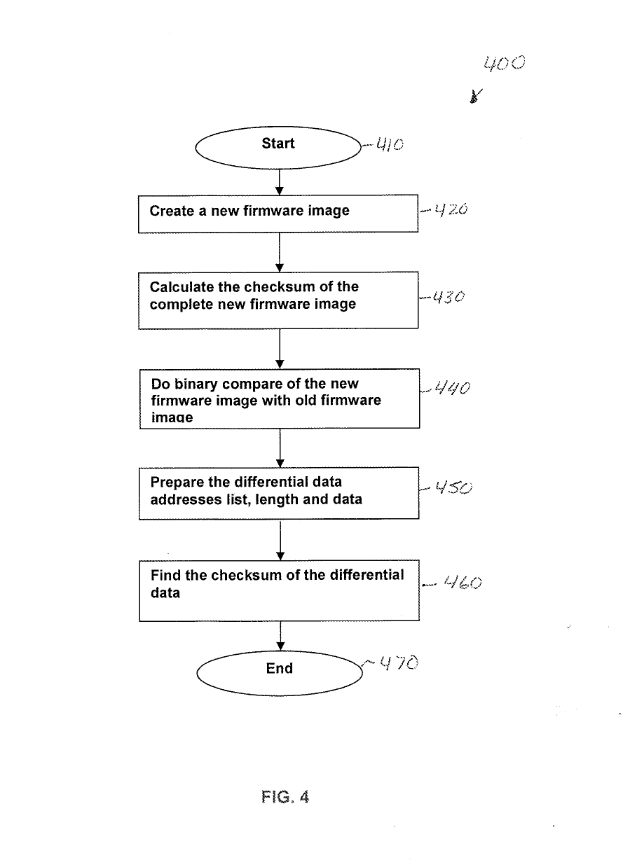

FIG. 3 is an illustration showing an existing firmware image structure 300 in accordance with an exemplary embodiment. As shown in FIG. 3, the existing firmware image structure 300 includes a complete current firmware image checksum 310, a current firmware image 320, a complete old firmware image checksum 330, an old list of differential addresses and data length 340, an old differential data image 350, and an old differential data checksum 360.

In accordance with an exemplary embodiment, as shown in FIG. 2, after creating a new firmware image, a binary comparison is performed with the old (or existing) firmware image, and based on the binary differences, a list of addresses and data length 220 can be generated wherein the new firmware image is different than the old firmware image. A new differential image 230 along with the list of addresses and data length where the new differential image is different from the old image is prepared. The checksum 240 of the completed new image and differential image checksum along with new differential data image is then stored as shown in the data structure 200 of FIG. 2

In accordance with an exemplary embodiment, during the updating of the existing firmware on the device 110, 130, 140, the checksum of the differential image can be crosschecked. If the calculated checksum is the same as the received checksum, than the installation of the new firmware image on the device is successful. The backup of the old image differential data can then be obtained and stored in a backup area. The new differential image data can then be applied to the old firmware image area. The checksum of the updated complete firmware image is then calculated and crosschecked with the stored complete checksum in the differential image. If both checksums match, then the firmware update has been successful, otherwise if the checksums do not match, the installation or updated can be considered to be incomplete or a failure.

In accordance with an exemplary embodiment, if a user wants to revert to the old image, one can restore the old firmware from the backed up differential data as disclosed herein. For example, if the old firmware image is desired, the backed up old firmware image differential data can be retrieved, which has been backed up and the complete old image checksum stored along with the old firmware image (or existing firmware) is crosschecked as shown in FIG. 3.

In accordance with an exemplary embodiment, the new firmware image differential data structure 200 as shown in FIG. 2, can be distributed (or downloaded) from, for example, the second computer device 120 to the first computer device 110, and/or the one or more client devices 130, 140 via the network connection 150, or in an offline format, for example, via a non-transitory computer readable medium containing a computer program storing computer readable code for updating firmware in a memory of a device as disclosed herein. In this exemplary embodiment, the second computer device 120 can be, for example, a manufacture of the first computer 110 and/or the one or more client devices 130, 140, who creates the firmware of the first computer 110 and/or the one more client devices 130, 140.

FIG. 4 is a flow chart showing an exemplary new firmware image differential data creation flowchart 400 in accordance with an exemplary embodiment. As shown in FIG. 4, the process starts in step 410. In step 420, a new firmware image is created. In step 430, a checksum (or checksum function) of the complete new firmware image is calculated. In step 440, a binary comparison of the new firmware with the old firmware image is performed. In step 450, the differential data address list, length and data are prepared. In step 460, the checksum of the differential data is found. In accordance with an exemplary embodiment, the process as disclosed in FIG. 4 can be carried out or performed, for example, on the second computer device 120, which can be located or hosted within a manufacture site.

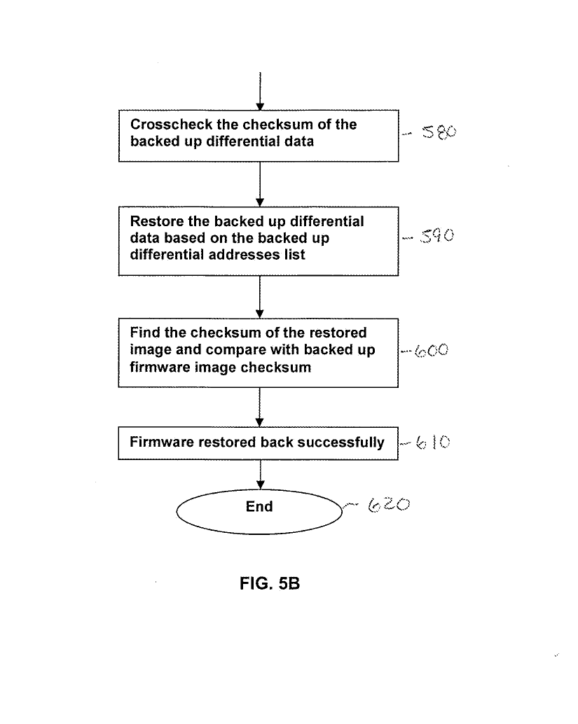

FIGS. 5A and 5B is a flow chart 500 showing an exemplary updating of the existing firmware image with received differential data in accordance with an exemplary embodiment. The process starts in step 510. In step 520, the checksum of the received differential data is found. In step 530, the calculated checksum with received differential data checksum is crosschecked. In step 540, the backup of the current or existing image checksum, differential addresses list, length, differential data, and its checksum are taken. In step 550, the current or existing firmware image is updated with the new image differential. In step 560, the checksum of the updated image is calculated and compared with the received firmware image checksum. If the calculated checksum is the same (or matches) as the received firmware image checksum, the process continues to step 570, wherein the firmware update is successful.

In accordance with an exemplary embodiment, if the calculated checksum is not the same (or does not match) the received firmware image checksum, the process continues to step 580, where the checksum of the backed up differential data is crosschecked. In step 590, the backed up differential data based on the backed up differential addresses list is restored. In step 600, the checksum of the restored image is found and compared with the backed up firmware image checksum. In step 610, if the checksum of the restored image matches the backed up firmware image checksum, the existing firmware image has been successfully restored. The process ends in step 620.

In accordance with an exemplary embodiment, if a user wants to revert to the existing firmware image, the user can restore the existing firmware as set forth in steps 580-620 as shown in FIG. 5B.

In accordance with an exemplary embodiment, for example, the processes as shown in FIGS. 5A and 5B can be performed in non-volatile memory devices such as ROM, EPROM, or flash memory.

In accordance with an exemplary embodiment, a non-transitory computer readable medium containing a computer program storing computer readable code for updating firmware in a memory of a device is disclosed, the computer program being executable by a computer to cause the computer to perform a process comprising: creating a new firmware image for the device; calculating a checksum of the new firmware image; performing a binary comparison of the new firmware image with an existing firmware image on the device; preparing a new differential data image for the binary comparison of the new firmware image to the existing firmware image; and calculating a checksum of the new differential data image for the binary comparison of the new firmware image to the existing firmware image.

In accordance with an exemplary embodiment, a non-transitory computer readable medium containing a computer program storing computer readable code for updating firmware in a memory of a device is disclosed, the computer program being executable by a computer to cause the computer to perform a process comprising: executing a computer file for installing a new firmware image in the memory of the device, the computer file including a checksum of the new firmware image, a new differential data image, the new differential data image being a binary comparison of the new firmware image to an existing firmware image, and a checksum of the new differential data image; crosschecking a calculated checksum of the new firmware image with the checksum of the new differential data image; obtaining a backed up differential data image of the existing firmware image, the backed up differential data image of the existing firmware image including a checksum, a list of differential addresses, and data length for the existing firmware image; and updating the existing firmware image with the new differential data image on the device to create an updated firmware image on the device.

The computer readable recording medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for updating firmware in a memory of a device, the method comprising:
creating a new firmware image for the device;
calculating a checksum of the new firmware image;
performing a binary comparison of the new firmware image with an existing firmware image on the device;
preparing a new differential data image for the binary comparison of the new firmware image to the existing firmware image;
calculating a checksum of the new differential data image for the binary comparison of the new firmware image to the existing firmware image; and
storing the checksum of the new firmware image, the new differential data image, and the checksum of the new differential data image in the memory of the device.

2. (canceled)

3. The method of claim 1, wherein the new differential data image includes a list of addresses and data length.

4. A method for updating firmware in a memory of a device, comprising:
executing a computer file for installing a new firmware image in the memory of the device, the computer file including a checksum of the new firmware image, a new differential data image, the new differential data image being a binary comparison of the new firmware image to an existing firmware image, and a checksum of the new differential data image;
crosschecking a calculated checksum of the new firmware image with the checksum of the new differential data image;
obtaining a backed up differential data image of the existing firmware image, the backed up differential data image of the existing firmware image including a checksum, a list of differential addresses, and data length for the existing firmware image;
updating the existing firmware image with the new differential data image on the device to create an updated firmware image on the device; and
storing the checksum of the new firmware image, the new differential data image, the checksum of the new differential data image, and the backed up differential data image of the existing firmware image in the memory of the device.

5. The method of claim 4, comprising:
calculating a checksum of the updated firmware image; and
comparing the calculated checksum of the updated firmware image with the calculated checksum of the new differential data image for the binary comparison of the new firmware image to the existing firmware image, to determine if the existing firmware was successfully updated with the new firmware.

6. The method of claim 5, wherein,
if the calculated checksum of the updated firmware image and the calculated checksum of the updated firmware image with the calculated checksum of the new differential data image for the binary comparison of the new firmware image to the existing firmware image match, determining that the existing firmware was successfully updated.

7. The method of claim 5, wherein
if the calculated checksum of the updated firmware image and the calculated checksum of the updated firmware image with the calculated checksum of the new differential data image for the binary comparison of the new firmware image to the existing firmware image do not match, determining that the existing firmware was not successfully updated.

8. The method of claim 7, comprising:
crosschecking a checksum of the backed up differential data image of the existing firmware image;
restoring the backed up differential data image based on the backed up differential list of addresses;
generating a checksum of the restored backed up image and comparing the checksum of the backed up firmware image with the restored backed up differential data image; and
if the checksum of the restored backed up differential data image and the checksum of the backed up firmware image match, the firmware has been successfully restored.

9. The method of claim 4, comprising:
reverting the updated firmware image on the device to the existing firmware upon request of a user from the new differential data image stored in the memory of the device.

10. The method of claim 4, comprising:
storing a program configured to execute the updating of the firmware in the memory of the device on a non-transitory readable medium.

11. A non-transitory computer readable medium containing a computer program storing computer readable code for updating firmware in a memory of a device, the computer program being executable by a computer to cause the computer to perform a process comprising:
creating a new firmware image for the device;
calculating a checksum of the new firmware image;
performing a binary comparison of the new firmware image with an existing firmware image on the device;
preparing a new differential data image for the binary comparison of the new firmware image to the existing firmware image;
calculating a checksum of the new differential data image for the binary comparison of the new firmware image to the existing firmware image; and
storing the checksum of the new firmware image, the new differential data image, and the checksum of the new differential data image in the memory of the device.

12. (canceled)

13. The computer readable storage medium of claim 11, wherein the new differential data image includes a list of addresses and data length.

14. A non-transitory computer readable medium containing a computer program storing computer readable code for updating firmware in a memory of a device, the computer program being executable by a computer to cause the computer to perform a process comprising:
executing a computer file for installing a new firmware image in the memory of the device, the computer file including a checksum of the new firmware image, a new differential data image, the new differential data image being a binary comparison of the new firmware image to an existing firmware image, and a checksum of the new differential data image;
crosschecking a calculated checksum of the new firmware image with the checksum of the new differential data image;
obtaining a backed up differential data image of the existing firmware image, the backed up differential data image of the existing firmware image including a checksum, a list of differential addresses, and data length for the existing firmware image;
updating the existing firmware image with the new differential data image on the device to create an updated firmware image on the device; and
storing the checksum of the new firmware image, the new differential data image, the checksum of the new differential data image, and the backed up differential data image of the existing firmware image in the memory of the device.

15. The computer readable storage medium of claim 14, comprising:
calculating a checksum of the updated firmware image; and
comparing the calculated checksum of the updated firmware image with the calculated checksum of the new differential data image for the binary comparison of the new firmware image to the existing firmware image, to determine if the existing firmware was successfully updated with the new firmware.

16. The computer readable storage medium of claim 15, wherein,
if the calculated checksum of the updated firmware image and the calculated checksum of the updated firmware image with the calculated checksum of the new differential data image for the binary comparison of the new firmware image to the existing firmware image match, determining that the existing firmware was successfully updated.

17. The computer readable storage medium of claim 15, wherein
if the calculated checksum of the updated firmware image and the calculated checksum of the updated firmware image with the calculated checksum of the new differential data image for the binary comparison of the new firmware image to the existing firmware image do not match, determining that the existing firmware was not successfully updated.

18. The computer readable storage medium of claim 17, comprising:
crosschecking a checksum of the backed up differential data image of the existing firmware image;
restoring the backed up differential data image based on the backed up differential list of addresses;
generating a checksum of the restored backed up image and comparing the checksum of the backed up firmware image with the restored backed up differential data image; and
if the checksum of the restored backed up differential data image and the checksum of the backed up firmware image match, the firmware has been successfully restored.

19. The computer readable storage medium of claim 14, comprising:
reverting the updated firmware image on the device to the existing firmware upon request of a user from the new differential data image stored in the memory of the device

20. The computer readable storage medium of claim 14, comprising:
storing a program configured to execute the updating of the firmware in the memory of the device on a non-transitory readable medium.

21. The method of claim 1, comprising:
storing a backed up differential data image of the existing firmware image in the memory of the device, the backed up differential data image of the existing firmware image including a checksum, a list of differential addresses, and data length for the existing firmware image; and
reverting the new firmware image on the device to the existing firmware upon request of a user from the backed up differential data image stored in the memory of the device.

22. The computer readable storage medium of claim 11, comprising:
storing a backed up differential data image of the existing firmware image in the memory of the device, the backed up differential data image of the existing firmware image including a checksum, a list of differential addresses, and data length for the existing firmware image; and
reverting the new firmware image on the device to the existing firmware upon request of a user from the backed up differential data image stored in the memory of the device.
